(19) United States
(12) Patent Application Publication
(10) Pub. No.: US 2026/0017769 A1
(43) Pub. Date: Jan. 15, 2026

(54) METHOD AND SYSTEM FOR VALIDATING IMAGES WITH OBSERVATIONS

(71) Applicant: HCL Technologies Limited, New Delhi (IN)

(72) Inventors: SRINIVAS TANGIRALA, Hyderabad (IN); NARENDER SIDDHAMSHETTY, Hyderabad (IN); KIRAN AYYAGARI, Hyderabad (IN); SRIHARI VARADHARAJAN, Chennai (IN)

(21) Appl. No.: 19/078,336

(22) Filed: Mar. 13, 2025

(30) Foreign Application Priority Data
Jul. 10, 2024 (IN) 202411052736

(51) Int. Cl. G06T 7/00; G06T 7/11; G06T 7/73; G06V 10/25; G06V 10/74; G06V 10/75; G06V 10/764; G06V 10/98; G06V 30/19; G06V 30/244

(52) U.S. Cl. CPC G06T 7/0002; G06T 7/11; G06T 7/74; G06V 10/759; G06V 10/761; G06V 10/764; G06V 10/987; G06V 30/19173; G06V 30/245; G06T 2200/24; G06T 2207/20104; G06T 2207/30168; G06V 10/25; G06V 2201/06

(57) ABSTRACT

A method for validating images with observations is disclosed. The method includes receiving production image and baseline image from user device. The method includes identifying a plurality of deviations in the production image from the baseline image using a similarity check algorithm. The method includes extracting first output corresponding to the plurality of deviations. The method includes creating, using cognizance Region of Interest (ROI) algorithm, one or more ROIs based on the position coordinates of each of the plurality of deviations. Each of the one or more ROIs comprises at least one deviation of the plurality of deviations. The cognizance ROI algorithm is based on Artificial Intelligence (AI). The method includes, for each ROI, generating, a second output corresponding to the ROI using one or more predictive models. The second output includes observations corresponding to each of the at least one deviation in the ROI.

### TECHNICAL FIELD

This disclosure relates generally to image validation and more particularly to a method and a system for validating images with observations.

### BACKGROUND

In digital engineering, User Interface (UI) plays an important role in enhancing end-user experience. The UI screen designs and contents are expected to change frequently to provide a better look and feel to enhance end-user experience. The design changes are frequently seen on platforms like Independent Software Vendor (ISV), e-commerce, retail, social media, advertisement, and applications in other domains (such as, product life cycle management, engineering drawings information management system, quality management system, etc.) where images of an existing product/drawing need to be compared with images of a newly designed product/drawing to identify differences between the two products.

In UI design, with the frequent changes, the web developers have to validate the contents of previous and new UI designs to ensure that critical text labels and UI elements in a web application are available. A tester may face a lot of challenges in accurately identifying all the differences manually between the two UI screens. A similar validation process is applied for applications in the other domains.

In the present state of art, various image comparison tools are developed to compare the images and highlight the differences. However, the reports provided by these tools include limited insights from a tester perspective. It may be challenging for the testing team to understand the type or nature of the highlighted differences. The testers need to spend ample amount of time with the tool outputs to note each highlighted difference. The key challenge from a testing point of view is to understand the nature of each highlighted difference.

The present invention is directed to overcome one or more limitations stated above or any other limitations associated with the known arts.

### SUMMARY

In one embodiment, a method for validating images with observations is disclosed. In one example, the method may include receiving a production image and a baseline image from a user device. The method may further include identifying a plurality of deviations in the production image from the baseline image using a similarity check algorithm. The method may further include extracting a first output corresponding to the plurality of deviations. It should be noted that the first output may include position coordinates of each of the plurality of deviations. The method may further include creating, using a cognizance ROI algorithm, one or more Regions of Interest (ROIs) based on the position coordinates of each of the plurality of deviations. It should be noted that each of the one or more ROIs may include at least one deviation of the plurality of deviations. It should also be noted that the cognizance ROI algorithm is based on Artificial Intelligence (AI). For each ROI of the one or more ROIs, the method may further include generating a second output corresponding to the ROI using one or more predictive models. It should be noted that the second output may include observations corresponding to each of the at least one deviation in the ROI.

In another embodiment, a system for validating images with observations is disclosed. In one example, the system may include a processor and a computer-readable medium communicatively coupled to the processor. The computer-readable medium may store processor-executable instructions, which, on execution, may cause the processor to receive a production image and a baseline image from a user device. The processor-executable instructions, on execution, may further cause the processor to identify a plurality of deviations in the production image from the baseline image using a similarity check algorithm. The processor-executable instructions, on execution, may further cause the processor to extract a first output corresponding to the plurality of deviations. It should be noted that the first output may include position coordinates of each of the plurality of deviations. The processor-executable instructions, on execution, may further cause the processor to create, using a cognizance ROI algorithm, one or more ROIs based on the position coordinates of each of the plurality of deviations. It should be noted that each of the one or more ROIs may include at least one deviation of the plurality of deviations. It should also be noted that the cognizance ROI algorithm is based on AI. For each ROI of the one or more ROIs, the processor-executable instructions, on execution, may further cause the processor to generate a second output corresponding to the ROI using one or more predictive models. It should be noted that the second output may include observations corresponding to each of the at least one deviation in the ROI.

In yet another embodiment, a non-transitory computer-readable medium storing computer-executable instructions for validating images with observations is disclosed. In one example, the stored instructions, when executed by a processor, may cause the processor to perform operations including receiving a production image and a baseline image from a user device. The operations may further include identifying a plurality of deviations in the production image from the baseline image using a similarity check algorithm. The operations may further include extracting a first output corresponding to the plurality of deviations. It should be noted that the first output may include position coordinates of each of the plurality of deviations. The operations may further include creating, using a cognizance ROI algorithm, one or more ROIs based on the position coordinates of each of the plurality of deviations. It should be noted that each of the one or more ROIs may include at least one deviation of the plurality of deviations. It should also be noted that the cognizance ROI algorithm is based on AI. For each ROI of the one or more ROIs, the operations may further include generating a second output corresponding to the ROI using one or more predictive models. It should be noted that the second output may include observations corresponding to each of the at least one deviation in the ROI.

It is to be understood that both the foregoing general description and the following detailed description are exemplary are explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for validating images with observations, in accordance with some embodiments of the present disclosure.

FIG. 2 illustrates a functional block diagram of various modules within a memory of a computing device configured to validate images with observations, in accordance with some embodiments of the present disclosure.

FIG. 3 illustrates a flow diagram of an exemplary process for validating images with observations, in accordance with some embodiments of the present disclosure.

FIGS. 4A-4H illustrate validation and report generation of an exemplary production image, in accordance with some embodiments of the present disclosure.

FIG. 5 illustrates a flow diagram of an exemplary process for validating segmented images, in accordance with some embodiments of the present disclosure.

FIGS. 6A-6C illustrate validation and segmented image report generation of an exemplary segmented image, in accordance with some embodiments of the present disclosure.

FIGS. 7A-7C illustrate validation and segmented image report generation of another exemplary segmented image, in accordance with some embodiments of the present disclosure.

FIG. 8 illustrates a flow diagram of a detailed exemplary control logic for validating images with observations, in accordance with some embodiments of the present disclosure.

FIG. 9 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

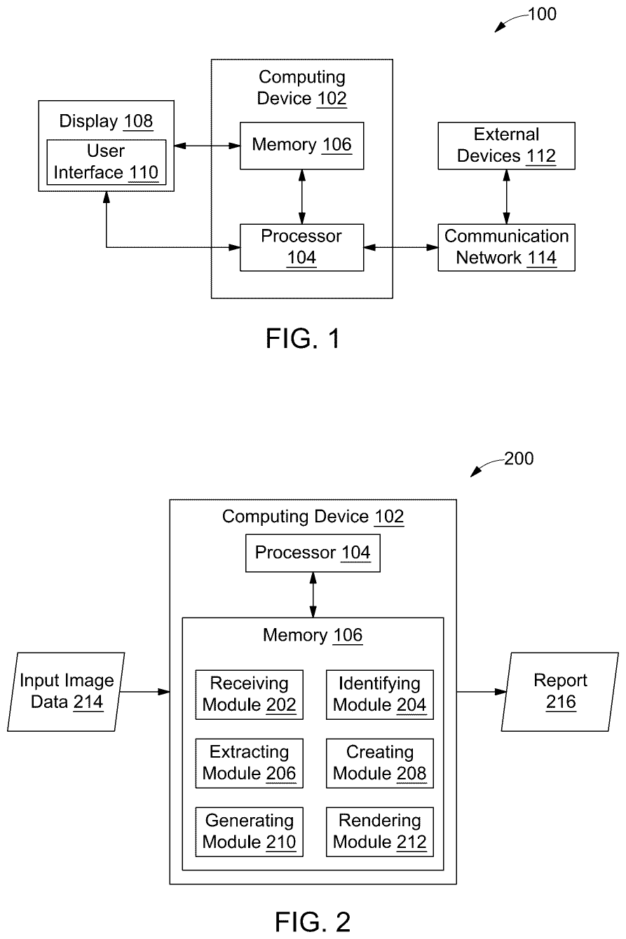

Referring now to FIG. 1, an exemplary system 100 for validating images with observations is illustrated, in accordance with some embodiments of the present disclosure. The system 100 may include a computing device 102. The computing device 102 may be, for example, but may not be limited to, server, desktop, laptop, notebook, netbook, tablet, smartphone, mobile phone, or any other computing device, in accordance with some embodiments of the present disclosure. The computing device 102 may validate images with observations using a cognizance Region of Interest (ROI) algorithm based on Artificial Intelligence (AI).

As will be described in greater detail in conjunction with FIGS. 2-9, in order to validate images with observations, the computing device 102 may receive a production image and a baseline image from a user device. The computing device 102 may further identify a plurality of deviations in the production image from the baseline image using a similarity check algorithm. The computing device 102 may further extract a first output corresponding to the plurality of deviations. It should be noted that the first output may include position coordinates of each of the plurality of deviations. The computing device 102 may further create, using a cognizance ROI algorithm, one or more ROIs based on the position coordinates of each of the plurality of deviations. It should be noted that each of the one or more ROIs may include at least one deviation of the plurality of deviations. It should also be noted that the cognizance ROI algorithm is based on AI. For each ROI of the one or more ROIs. The computing device 102 may further generate a second output corresponding to the ROI using one or more predictive models. It should be noted that the second output may include observations corresponding to each of the at least one deviation in the ROI.

In some embodiments, the computing device 102 may include one or more processors 104 and a memory 106. Further, the memory 106 may store instructions that, when executed by the one or more processors 104, may cause the one or more processors 104 to validate images with observations, in accordance with aspects of the present disclosure. The memory 106 may also store various data (for example, a baseline image, a production image, a segmented image, a first output, a second output, a report, a summary report, and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may further include a display 108. The system 100 may interact with a user interface 110 accessible via the display 108. The system 100 may also include one or more external devices 112. In some embodiments, the computing device 102 may interact with the one or more external devices 112 over a communication network 114 for sending or receiving various data. The communication network 114 may include, for example, but may not be limited to, a wireless fidelity (Wi-Fi) network, a light fidelity (Li-Fi) network, a local area network (LAN), a wide area network (WAN), a metropolitan area network (MAN), a satellite network, the internet, a fiber optic network, a coaxial cable network, an infrared (IR) network, a radio frequency (RF) network, and a combination thereof. The one or more external devices 112 may include, but may not be limited to, a remote server, a laptop, a netbook, a notebook, a smartphone, a mobile phone, a tablet, or any other computing device.

Referring now to FIG. 2, a functional block diagram of a system 200 is illustrated, in accordance with some embodiments of the present disclosure. FIG. 2 is explained in conjunction with FIG. 1. The system 200 may be analogous to the system 100. The system 200 may implement the computing device 102. The memory 106 of the computing device 102 may include a receiving module 202, an identifying module 204, an extracting module 206, a creating module 208, a generating module 210, and a rendering module 212.

As will be appreciated, image validation may be required for monitoring changes in application User Interface (UI), digital drawings, sketches, or webpage screens. The receiving module 202 may receive input image data 214 from a user device (such as a server, a laptop, a netbook, a notebook, a smartphone, a mobile phone, a tablet, and any other computing device).

In an embodiment, the input image data 214 may include a baseline image and a production image. The baseline image may be a previous version image that may be used as a reference image. The production image may be a current (or live) version image that may or may not include changes made to the baseline image. By way of an example, the production image and the baseline image may correspond to webpages (e.g., home pages, blog pages, landing pages, profile pages, contact pages, help pages, etc.), Computer-Aided Design (CAD) models e.g., 2D or 3D CAD models), advertisement images, symbols, applications User Interface (UI) designs, digital drawings, sketches, icons, and the like. Therefore, in an exemplary scenario where the baseline image and the production image correspond to a home page of a website, the baseline image may be a previous version of the home page (i.e., an older version) and the production image may be a live version of the home page. The production image may include changes made to the previous version of the home page (corresponding to the baseline image).

The production image and the baseline image may be pre-stored in a database. The receiving module 202 may retrieve the production image and the baseline image from the database. The production image and the baseline image may be received in an image format (such as Portable Network Graphics (PNG), Joint Photographic Expert Group (JPEG) or (JPG), Bitmap (BMP), Joint Interchange File Format (JIFF), a Scalable Vector Graphics (SVG), etc.), a document format (such as Portable Document Format (PDF)), or a text format (such as a Comma Separated Value (CSV) file that includes image data (e.g., matrix representation of the image).

Various browser options to validate images in form of headless, normal mode are supported, allowing multi-dimensional image validation and X-factor validations. The various supported browser options may enable testers to cover a wide range of input image combinations for performing image validations in testing cycles to accomplish the tasks seamlessly. The baseline image and the production image may be received as images (i.e., in image format) or extracted from a URL of an application in real-time. Thus, the wide range of input image combinations may include, but may not be limited to, an image-to-image combination option, an image-to-URL combination option, a URL-to-image combination option, a URL-to-URL combination option, and an X-factor option.

The image-to-image combination option may allow the receiving module 202 to receive both the baseline image and the production image in image format (e.g., images of drawings, sketches, advertisement templates, and the like). The image-to-URL combination option may allow the receiving module 202 to receive the baseline image in the image format from a database or a repository. In this option, the production image may be extracted from the URL of the application in real-time (i.e., live screen of the application). The URL-to-image combination option may allow the receiving module 202 to receive the production image in the image format from a database or a repository. In this option, the baseline image may be extracted from the URL of the application in real-time (for example, when the application is under development). The URL-to-URL combination option may allow the receiving module 202 to extract both the baseline image and the production image from the URL of the application in real-time. The X-factor option may allow the receiving module 202 to receive a segmented image (i.e., a portion of an image) to find a match (exact match or nearest match) of the segmented image in the baseline image, the production image, or both. Thus, the input image data 214 includes two images, i.e., the baseline image and the production image, for each of the input image combinations except the X-factor option. Further, the receiving module 202 may send the input image data 214 to the identifying module 204.

The identifying module 204 may process the input image data 214 based on the input combination of the input image data 214. When the input image combination is one of the image-to-image combination option, the image-to-URL combination option, the URL-to-image combination option, or the URL-to-URL combination option, the identifying module 204 may identify a plurality of deviations in the production image from the baseline image using a similarity check algorithm. By way of an example, the plurality of deviations may include, but may not be limited to, deviations in image, deviations in alignment, deviations in background, deviations in font style, deviations in font size, deviations in color, missing image, and the like. The similarity check algorithm may include, for example, but may not be limited to, a Manhattan distance, a Euclidean distance, a cosine similarity, a Jaccard similarity, a Structural similarity, and a Hamming similarity.

The identifying module 204 may use the similarity check algorithm to verify the format of the input image data 214 format and ensure to convert both the images to suitable format for image validation. In other words, the identifying module 204, via the similarity check algorithm, may identify the format of each of the baseline image and the production image and convert the format to a suitable format (if required) for further processing. In addition, the identifying module 204, via the similarity check algorithm, may also check the image quality to apply preprocessing methods to improve image richness as per requirement. The image validation may be performed on a pixel level to identify the plurality of deviations between the production image and the baseline image.

Once the identifying module 204 identifies the plurality of deviations, the extracting module 206 may generate boxes of different shapes (e.g., rectangular, circular, square, and the like) and colors (e.g. yellow, red, blue, and the like) to highlight each of the plurality of deviations on the production image. Further, the extracting module 206 may assign a first unique ID to each of the plurality of deviations. The first unique ID may be, for example, but may not be limited to, a numeric value, an alphabetic character, a roman numeral, or an alpha-numeric value. Further, the extracting module 206 may extract a first output corresponding to the plurality of deviations. The first output may also be known as a naive (or standard) output. It should be noted that the first output may include position coordinates of each of the plurality of deviations. The position coordinates may include, for example, X-axis coordinates and Y-axis coordinates of each of the plurality of deviations. The first output may further include the first unique ID of each of the plurality of deviations.

Upon extracting the first output along with the first unique ID by the extracting module 206, the creating module 208 may create one or more ROIs based on the position coordinates of each of the plurality of deviations using a cognizance ROI algorithm. It should be noted that each of the one or more ROIs may include at least one deviation of the plurality of deviations. The cognizance ROI algorithm may be based on AI. The cognizance ROI algorithm may identify deviations with overlapping position coordinates, deviations corresponding to many smaller regions present inside a larger region, deviations with minimal distance, etc., based on the position coordinates obtained in the first output. The creating module 206 may then group such deviations together into an ROI. The cognizance ROI algorithm enhances regions (i.e. bounding boxes) corresponding to the deviations to perform intelligent segmentation to obtain meaningful ROIs. Further, the creating module 206 may assign a second unique ID to each of the one or more ROIs. The second unique ID may include, for example, but may not be limited to, a numeric value, an alphabetic character, a roman numeral, and an alpha-numeric value.

For each ROI of the one or more ROIs, the generating module 210 may generate a second output corresponding to the ROI using one or more predictive models. The second output may include observations corresponding to each of the at least one deviation in the ROI. In an embodiment, the generating module 210 may perform validations (i.e., check for deviations) of at least one of text, font, and images in the input image data 214. The generating module 210 may compare position coordinates of the production image with corresponding regions in the baseline image for all the validations. Further, the second output may also include the second unique ID of each of the one or more ROIs.

When the input image data 214 includes text information, the generating module 210 may check for any text deviations in the ROI using a text extraction model. The generating module 210 may then identify one or more text deviations in the ROI using the text extraction model. The one or more text deviations may include, for example, but may not be limited to, missing text, new text, change in text size, or change in text color. The text extraction model may be based on deep learning. In some embodiments, the text extraction model may extract the text using a deep learning-based Optical Character Recognition (OCR) model that performs checks for text (i.e. missing, new addition, size, color, shift, etc.).

Further, the generating module 210 may identify a font deviation in the ROI using a font classification model. The font deviation may include, for example, but may not be limited to, a font style (e.g., a Times New Roman, an Arial, an Aptos, a Calibri, a Calibri light, and an Aptos Display, and the like). By way of an example, in an ROI of the production image, the font style may be ‘Times New Roman’ and in a corresponding ROI of the baseline image, the font style may be ‘Arial’. The font classification model may be based on the deep learning. In a preferred embodiment, the generating module 210 may perform validations for deviations in text and font in the input image data 214 only when any text information is detected in the ROI. In cases where any text information is not detected in the ROI, the generating module 210 may directly perform validation for deviations in images in the input image data 214 using an image validator model.

The generating module 210 may check for deviations in images in the input image data 214 using the image validator model. The generating module 210 may identify an image deviation in the ROI using an image validator model. The deviations in images may include, for example, but may not be limited to, change in background color, change in image dimensions, image shift, image missing, or completely different image.

Once the second output is generated by the generating module 210, the rendering module 212 may render a report 216 (i.e., a smart report) based on the second output on the user device. The report 216 may be in a format, for example, PDF, word document (DOC or DOCX), Microsoft excel spreadsheet files (XLS and XLSX), HTML, and the like. The report 216 may contain information about the position coordinates, the second unique ID corresponding to each of the one or more ROIs, and a callout and a remark for each of the one or more ROIs identified in the production image. In other words, the report 216 may consist of the changes observed with respect to text, UI elements, font style, alignment, font size, pictures, tables, and the like. The report 216 may include a summary report. In an embodiment, the user may have a provision to obtain the summary report by defining the parameters in a configuration file. The configuration file may also provide an option to adjust the parameters (such as highlighter colour (i.e., marking box), ROI number colour, and X-factor threshold). The report 216 may help to provide detailed insights to the user for each of the plurality of deviations identified in the production image.

Further, the rendering module 212 may also be configured to identify a cursor position on a Graphical User Interface (GUI) from the user device. When the cursor position corresponds to the position coordinates of an ROI from the one or more ROIs, the rendering module 212 may render the observations as a callout corresponding to each of the at least one deviation in the ROI. The callout may be rendered as a callout box GUI element on the GUI when the cursor on the user device is detected as hovering over the ROI. The callout may display all the deviations identified in the ROI. The callout may include, for example, but may not be limited to, a ‘distinct picture’, an ‘image shift’, a ‘difference in dimension’, an ‘image missing’, a ‘change in font’, a ‘text size’, a ‘change in background’, a ‘text alignment’, a ‘text difference’, and a ‘font color change’.

The ‘distinct picture’ callout may indicate that the ROI is completely different in the production image versus the baseline image. The ‘image shift’ callout may indicate that a change is detected in position of the image (i.e., shift right, shift left, shift top and shift bottom). For example, the image may still be the same but a shift in ROI may be detected. The ‘difference in dimension’ callout may imply a change in size of the image (i.e., larger or smaller). The ‘image missing’ callout may indicate that the object/element in the baseline image is not present in the production image. The ‘change in font’ callout may indicate a change in font style. By way of an example, in the baseline image, the font style may be in “Times New Roman” and in the production image, the font style may be “Arial”. The ‘text size’ callout may indicate a change in the size of the text. Text content may be the same, but the size of the characters may vary. The ‘change in background’ callout may indicate colour change in the background of an element. By way of an example, the background of an element may be in white colour in the baseline image and in a different colour in the production image. The ‘text alignment’ callout may indicate that a change is detected in position of the text (i.e., shift right, shift left, shift top and shift bottom) within the ROI. The text is still the same but a change in alignment within the ROI may be detected. The ‘text difference’ callout may indicate deletion/addition of the text. Single/multiple character differences in the ROI may be detected. The ‘font colour change’ callout may indicate a change in colour of font. The colour of the text in an ROI of the baseline image may be different from the colour of the text in the corresponding ROI of the production image. The mouse hover reporting may enable the user to view the callouts only by dragging the cursor on each of the one or more ROIs on the GUI.

When the input image combination is the X-factor option, the identifying module 204 may receive a segmented image (i.e., a part of an image such as an ROI) and a target image (i.e., at least one of the production image and the baseline image) from the receiving module 202. For example, the segmented image may be an object, an element, a text, or any portion of an image that needs to be validated. The X-factor option allows the testers to find an actual match in the target image.

Further, the identifying module 204 may search for a matching element corresponding to the segmented image in the target image. Based on the search, the identifying module 204 may identify a matching element corresponding to the segmented image from the target image (i.e., successful identification of the matching element). There may be more than one matching elements in the target image. There may also be no matching elements found in the target image (i.e., unsuccessful identification of the matching element).

Further, the identifying module 204 and/or the extracting module 206 may analyze the segmented image and the target image, based on a successful identification or an unsuccessful identification of the matching element.

Upon successful identification of the matching element (i.e., when one or more exactly matching elements (100% match) are found), the extracting module 206 may determine position coordinates of the matching element in the target image. The determined position coordinates may be used to highlight the matching element in the target image.

Upon unsuccessful identification of the matching element (i.e., when an exactly matching element (100% match) is not found), the identifying module 204 may identify a nearest matching element corresponding to the segmented image using the similarity check algorithm, based on a predefined threshold similarity score. In such scenarios, even though the segmented image is available in the target image, due to dimension/resolution changes there may be chances of unsuccessful identification since a 100% match cannot be established with the segmented image. The unsuccessfully matched regions are passed to a similarity check algorithm. The identifying module 204, via the similarity check algorithm, searches for a nearest match to the segmented image in the target image. The similarity check algorithm may check for the predefined threshold similarity score set in a configuration file to provide the nearest matching element based on a set of predefined parameters. In some embodiments, if the predefined threshold similarity score is not set in configuration file, then the default values for the predefined threshold similarity score may be 70%. Thus, any element with a similarity score greater than 70% may be selected. Further, the extracting module 206 may determine the position coordinates of the identified nearest matching element in the target image. The determined position coordinates may be used to highlight the nearest matching element in the target image.

The identified matching elements or nearest matching elements, along with the associated position coordinates, are then included in the second output and the subsequent report 216 based on the second output. Further, the rendering module 212 may render the report 216 (i.e., a segmented image report) based on the analysis on the user device.

It should be noted that all such aforementioned modules 202-212 may be represented as a single module or a combination of different modules. Further, as will be appreciated by those skilled in the art, each of the modules 202-212 may reside, in whole or in parts, on one device or multiple devices in communication with each other. In some embodiments, each of the modules 202-212 may be implemented as dedicated hardware circuit comprising custom application-specific integrated circuit (ASIC) or gate arrays, off-the-shelf semiconductors such as logic chips, transistors, or other discrete components. Each of the modules 202-212 may also be implemented in a programmable hardware device such as a field programmable gate array (FPGA), programmable array logic, programmable logic device, and so forth. Alternatively, each of the modules 202-212 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module, and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for validating images with observations. For example, the exemplary system 100 and the associated computing device 102, may validate images with observations by the processes discussed herein. In particular, as will be appreciated by those of ordinary skill in the art, control logic and/or automated routines for performing the techniques and steps described herein may be implemented by the system 100 and the associated computing device 102, either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

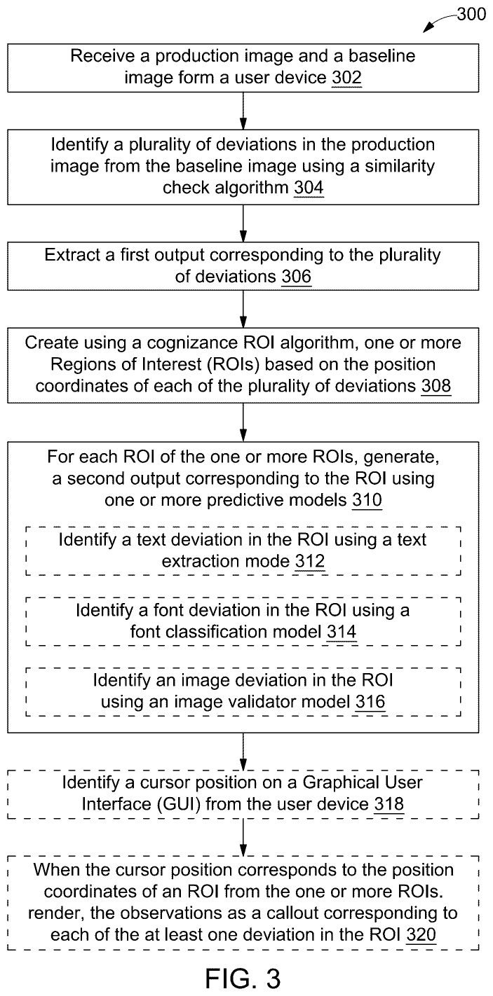

Referring now to FIG. 3, an exemplary process 300 for validating images with observations is illustrated via a flow chart, in accordance with some embodiments of the present disclosure. The process 300 may be implemented by the computing device 102 of the system 100. The process 300 may include receiving, by the receiving module 202, a production image and a baseline image from a user device, at step 302. The production image may be the modified version of the baseline image that may be under development. The baseline image may be the developed image (i.e. existing image) used as a reference image to identify the differences in the production image.

Further, the process 300 may include identifying, by the identifying module 204, a plurality of deviations in the production image from the baseline image using a similarity check algorithm, at step 304. The similarity check algorithm may verify the images format and ensure to convert both the images (i.e. baseline image and the production image) to suitable format for validations. In addition, the similarity check algorithm may also check for the image quality to apply preprocessing methods to improve the image richness as per requirement. The image validation may be performed on the pixel level to identify all the deviations between the images (i.e. the baseline image and the production image) under test.

Further, the process 300 may include extracting, by the extracting module 206, a first output corresponding to the plurality of deviations, at step 306. It should be noted that each of the plurality of deviations may be highlighted with the boxes of different shapes (e.g. rectangular) and colours (e.g. yellow). Further, each of the plurality of deviations may be assigned the first unique ID (i.e. numeric value). Further, the first output may include position coordinates of each of the plurality of deviations. Further, the first output may also include the first unique ID of each of the plurality of deviations.

Further, the process 300 may include creating, by the creating module 208, one or more ROIs based on the position coordinates of each of the plurality of deviations by using a cognizance ROI algorithm, at step 308. Each of the one or more ROIs may include at least one deviation of the plurality of deviations. It should be noted that the cognizance ROI algorithm may be based on AI. The cognizance ROI algorithm may be configured to identify the position coordinates of each of the plurality of deviations that may correspond to overlapping. Further, the cognizance ROI algorithm may combine all the identified overlapped position coordinates of each of the plurality of deviations and represent it with the single ROI. Further, the cognizance ROI algorithm may assign the second unique ID (i.e. numeric values) to each of the one or more ROIs on the production image.

For each ROI of the one or more ROIs, the process 300 may include generating, by the generating module 210, a second output corresponding to the ROI using one or more predictive models, at step 310. The second output may include observations corresponding to each of the at least one deviation in the ROI. Further, the second output may include the second unique ID of each of the one or more ROIs.

The step 310 of the process 300 may include identifying a text deviation in the ROI using a text extraction model, at step 312. The text extraction model is based on deep learning based optical character recognition (OCR). The production image along with the ROIs may only be sent to the text extraction model when each of the one or more ROIs may include the text contents (or information). The step 310 may further include identifying a font deviation in the ROI using a font classification model, at step 314. The font classification model may be based on the deep learning. The production image along with ROIs may be sent to the font classification model only when the ROIs may include the text information.

In an embodiment, the text extraction model may perform the extraction process and validation only when the ROIs may contain the text information. In all other cases, the production image along with the ROIs may be directly sent to an image validator model for further processing. The step 310 may further include identifying an image deviation in the ROI using the image validator model, at step 316.

Further, the process 300 may include identifying, by the rendering module 212, a cursor position on a GUI from the user device, at step 318. When the cursor position corresponding to the position coordinates of an ROI from the one or more ROIs. Further, the process 300 may include rendering, by the rendering module 212, the observations as a callout corresponding to each of the at least one deviation in the ROI, at step 320. In an embodiment, a mouse hover reporting option may also be available for the user to view the callouts easily for future reference.

Further, the process 300 may include rendering, by the rendering module 212, a report based on the second output on the user device. The report may include the information about the ROI number, the position coordinates, the callouts, and the remarks associated with each of the one or more ROIs. In some embodiment, the user may have provision to get the summary report by setting the parameter in a configuration file. The configuration file may also provide an option to adjust the parameters like highlighter colour of the bounding box, colour of the ROI number, and X-factor threshold. The summary report may help the user to view the detailed information corresponding to the one or more ROIs easily in short period of time for future reference.

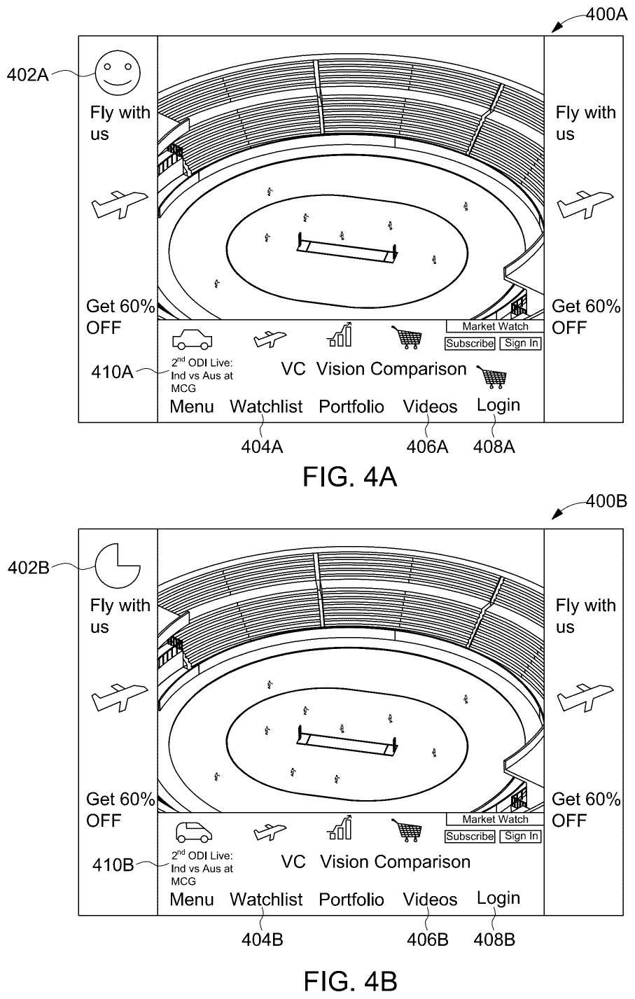

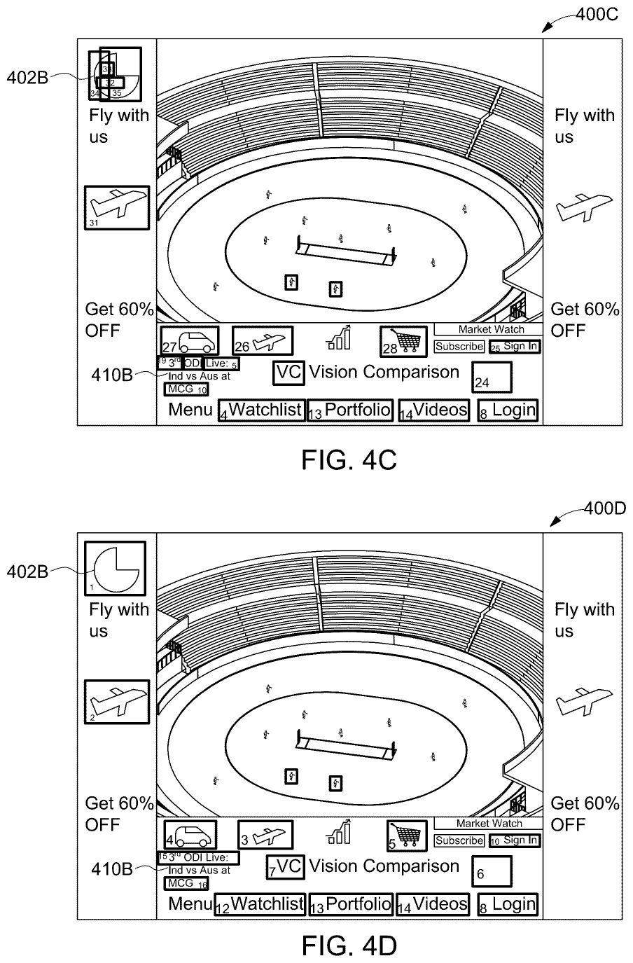

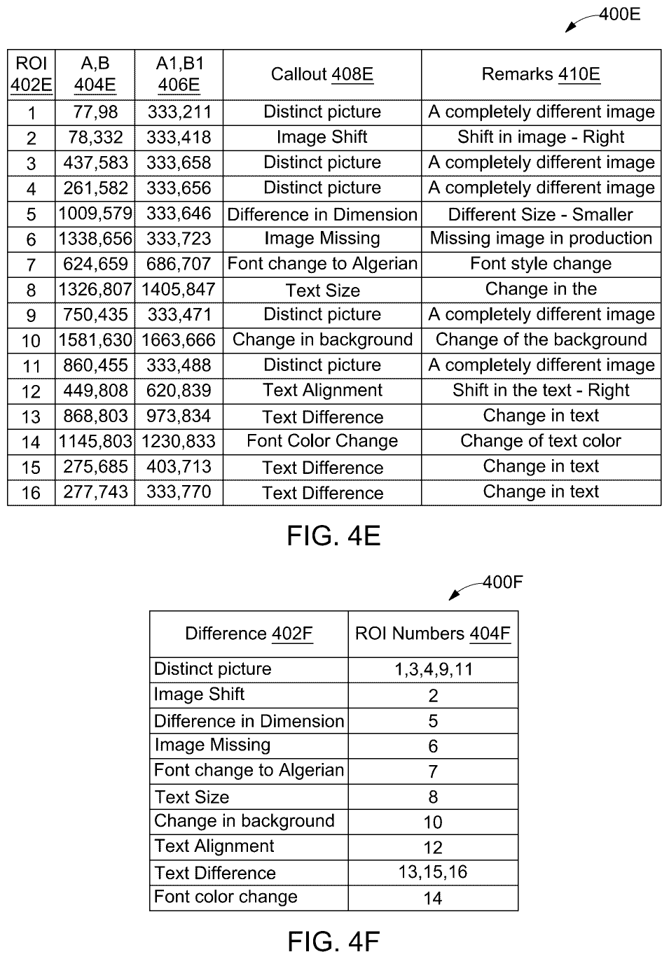

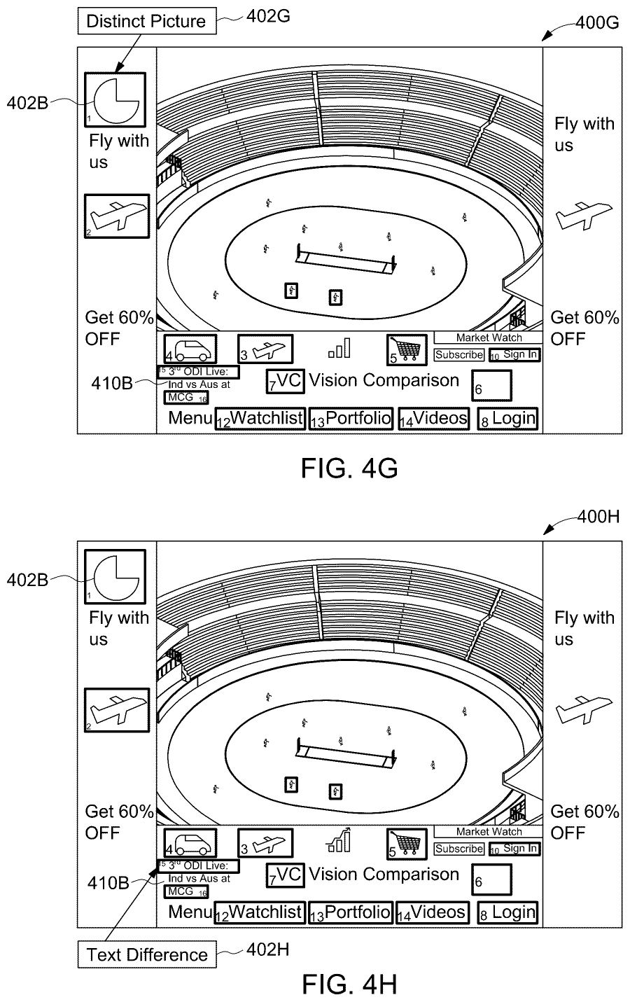

Referring now to FIGS. 4A-4H, validation and report generation of an exemplary production image are illustrated, in accordance with some embodiments of the present disclosure. FIGS. 4A-4H are explained in conjunction with FIGS. 1-3.

In FIG. 4A, a baseline image 400A is illustrated. The baseline image 400A may be received from the user device or may be pre-stored in a database. The baseline image may be a previous version of an image (for example, a screen of a previous version of an application UI). The baseline image 400A may be used as the reference image to detect the differences (or changes made) in the production image. By way of an example, the baseline image 400A may include a plurality of elements. The plurality of elements may include, for example, an element 402A, an element 404A, an element 406A, an element 408A, an element 410A, and the like.

In FIG. 4B, a production image 400B is illustrated. The production image 400B may be received from the user device. The production image 400B may be a modified version (or a live version) of the baseline image 400A (or any other similar image). The production image 400B may also include a plurality of elements. The plurality of elements may include, for example, an element 402B, an element 404B, an element 406B, an element 408B, an element 410B, and the like. In some embodiments, the production image 400B may contain some new or modified elements from the baseline image 400A. The baseline image 400A and the production image 400B may be received through one of the image-to-image combination option, the image-to-URL combination option, the URL-to-image combination option, or the URL-to-URL combination option.

Upon receiving the baseline image 400A and the production image 400B, the identifying module 204 may identify the plurality of deviations in the production image 400B from the baseline image 400A using the similarity check algorithm. In continuation with the above example, the similarity check algorithm may identify the plurality of deviations between elements of the production image 400B and the corresponding elements of the baseline image 400A. The element 402A may be compared with the element 402B. Similarly, the element 404A may be compared with the element 404B, the element 406A may be compared with the element 406B, and so on.

In FIG. 4C, a first output 400C is illustrated. Upon identifying the plurality of deviations by the identifying module 204, the extracting module 206 may draw the bounding boxes of different shapes (e.g., rectangular, elliptical, etc.) and colour (e.g., yellow, blue, green, etc.) and highlight each of the plurality of deviations on the production image 400B. Further, the extracting module 206 may assign the first unique ID to each of the identified plurality of deviations on the production image 400B. In continuation with the above example, in the production image 400B, the element 402B may include four deviations. The extracting module 206 may individually assign the first unique ID to each of the four deviations in element 402B. The extracting module 206 may assign the first unique ID ‘1’, ‘2’, ‘3’, and ‘4’ to each of the four deviations. Similarly, the element 404B may be assigned a first unique ID ‘5’, the element 406B may be assigned a first unique ID ‘6’, the element 408B may be assigned a first unique ID ‘7’, and the element 410B may be assigned a first unique ID ‘8’, and so on. It should be noted that for ease of illustration, the first unique IDs of a few exemplary ROIs are shown in FIG. 4C. However, preferred embodiments of the present disclosure may display the first unique IDs for each of the plurality of deviations in the first output, when rendered to the user device.

In FIG. 4D, a second output 400D is illustrated. Upon extracting the first output by the extracting module 206, the creating module 208 may create one or more ROIs based on the position coordinates of each of the plurality of deviations, using the cognizance ROI algorithm. Each of the one or more ROIs may include at least one deviation of the plurality of deviations. In continuation with the above example, the element 402B may have four deviations along with four associated first unique IDs (i.e., ‘1’, ‘2’, ‘3’, and ‘4’). The bounding boxes of such deviations in the first output may be overlapping with each other. Such scenarios may create confusion for the user.

Thus, the creating module 208, using the cognizance ROI algorithm, may combine all the four deviations of the element 402B and may create a common ROI for the four deviations. Further, the creating module 208, using the cognizance ROI algorithm, may assign a second unique ID to the ROI. Similarly, the creating module 208, using the cognizance ROI algorithm, may assign a second unique ID to each of the one or more ROIs created corresponding to the plurality of deviations identified in the production image 400B. The deviations corresponding to the first unique IDs ‘1’, ‘2’, ‘3’, and ‘4’ may be assigned a second unique ID ‘1’. Similarly, the deviation corresponding to the first unique ID ‘4’ may be assigned a second unique ID ‘2’, the deviation corresponding to the first unique ID ‘5’ may be assigned a second unique ID ‘3’, the deviation corresponding to the first unique ID ‘6’ may be assigned a second unique ID ‘4’, the deviation corresponding to the first unique ID ‘7’ may be assigned a second unique ID ‘5’, and so on. It should be noted that for ease of illustration, the second unique IDs of a few exemplary ROIs are shown in FIG. 4D. However, preferred embodiments of the present disclosure may display the second unique IDs for each of the one or more ROIs in the second output, when rendered to the user device.

Further, the generating module 210 may generate the second output 400D corresponding to the ROI using one or more predictive models. The second output 400D may include the observations corresponding to each of the at least one deviation in the ROI. The generating module 210 may perform the image validations using the one or more predictive models (such as the text extraction model, the font classification model, and the image validator model).

In continuation with the above example, the ROI with the second unique ID ‘1’ and the ROI with the second unique ID ‘5’ may not be sent to the text extraction model because these ROIs do not contain any text information. The ROI with the second unique ID ‘3’ and the ROI with the second unique ID ‘4’ may be sent to the text extraction model for identifying text deviations because these ROIs contain text information The ROIs with the second unique IDs ‘1’ and ‘5’ may be directly sent to the image validator model.

In FIG. 4E, a detailed report 400E is illustrated. In an embodiment, the detailed report 400E may be analogous to the report 216. The detailed report 400E is presented in a tabular format. The rendering module 212 may render the detailed report 400E based on the second output 400D on the user device. The detailed report 400E may include a column for ROI number 402E (i.e., a second unique ID) of an ROI, a column for position coordinates of top left point of the ROI (A, B) 404E, a column for position coordinates of bottom right point of the ROI (A1, B1) 406E, a column for callout 408E corresponding to the ROI, and a column of remarks 410E (i.e., additional information corresponding to the callout). In continuation with the above example, following are some exemplary values presented in the report 400E corresponding to the second output 400D. Remaining values can be referred to in the report 400E presented in FIG. 4E.

For an ROI with the ROI number 402E ‘1’ in the second output 400D, the position coordinates (A, B) 404E may be (77, 98), the position coordinates (A1, B1) 406E may be (333, 211), the callout 408E may be ‘Distinct picture’, and remarks 410E may be ‘A completely different image’.

For an ROI with the ROI number 402E ‘5’, the position coordinates (A, B) 404E may be (1009, 579), the position coordinates (A1, B1) 406E may be (333, 646), the callout 408E may be ‘Difference in Dimension’, and the remarks 410E may be ‘Different size-Smaller’.

For an ROI with the ROI number 402E ‘14’, the position coordinates (A, B) 404E may be (1145, 803), the position coordinates (A1, B1) 406E may be (1230, 833), the callout 408E may be ‘Font color change’, and the remarks 410E may be ‘Change of text color’.

In FIG. 4F, a summary report 400F is illustrated. In an embodiment, the summary report 400F may be analogous to the report 216. The summary report 400F is presented in a tabular format. The summary report 400F may include a column for difference 402F and a column for ROI number 404F. The column for difference 402F may include values for callouts as generated in the detailed report 400E. The column for ROI number 404F may include second unique IDs of all the ROIs which have same callouts in the detailed report 400E. By way of an example, the ROIs corresponding to the ROI numbers 404F ‘1’, ‘3’, ‘4’, ‘9’, and ‘11’ have the same callouts (i.e., ‘Distinct picture’) in the detailed report 400E. Thus, in the summary report 400F, the ROIs corresponding to the ROI numbers 404F ‘1’, ‘3’, ‘4’, ‘9’, and ‘11’ may be grouped under the same difference 402F.

In FIGS. 4G-4H, some exemplary GUIs showing callouts generated upon user cursor hovering over ROIs are illustrated. The rendering module 212 may identify the cursor position on the GUI from the user device. When the cursor position corresponds to the position coordinates of an ROI from the one or more ROIs, the rendering module 212 may render the corresponding observations generated in the second output as a callout corresponding to each of the at least one deviation in the ROI. In FIG. 4G, a GUI 400G is rendered on the user device. The GUI 400G may display the second output 400D. Further, when the user drags the cursor on the GUI 400G to a position of an ROI, such as the ROI with the second unique ID ‘1’, corresponding to the element 402B, then the rendering module 212 may render a callout 402G displaying the corresponding observation (i.e., ‘Distinct Picture’) on the GUI 400G.

In FIG. 4H, a GUI 400H is rendered on the user device. The GUI 400H may display the second output 400D. Further, when the user drags the cursor on the GUI 400H to a position of an ROI, such as the ROI with the second unique ID ‘15’, corresponding to the element 410B, then the rendering module 212 may render a callout 402H displaying the corresponding observation (i.e., ‘Text Difference’) on the GUI 400G.

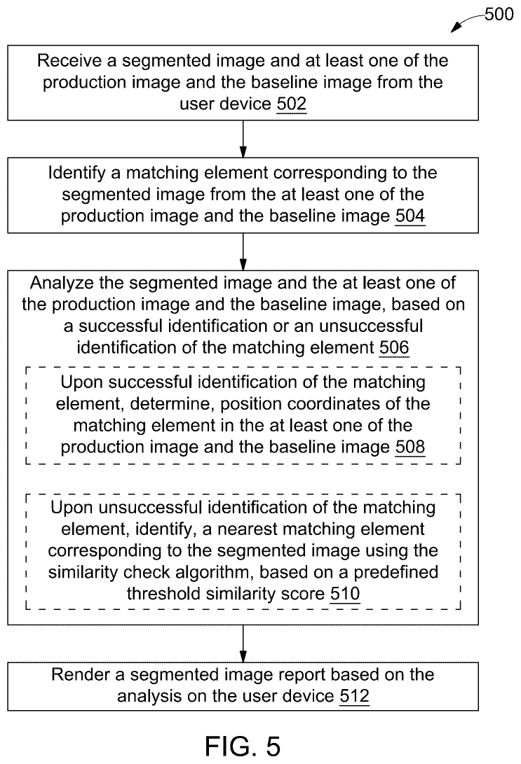

Referring now to FIG. 5, a process for validating a segmented image via a flow chart, in accordance with some embodiments of the present disclosure. FIG. 5 is explained in conjunction with FIGS. 1-4A-H. The process 500 may be implemented by the computing device 102 of the system 100. The process 500 may include receiving, by the receiving module 202, a segmented image and at least one of the production image 400B and the baseline image 400A from the user device, at step 502. The segmented image may include, for example, but may not be limited to, an object, a text, an element, or any other cropped portion of the image that needs to be validated. This feature may enable the user to find the actual match in the target image (i.e. at least one of the production image 400B and the baseline image 400A). In some embodiment, the receiving module 202 may receive the segmented image and a target image (i.e., at least one of the baseline image (e.g., the baseline image 400A) and the production image (e.g., the production image 400B)).

Upon receiving the segmented image and the target image, the process 500 may include identifying, by the identifying module 204, a matching element corresponding to the segmented image from the at least one of the production image 400B and the baseline image 400A, at step 504.

Further, the process 500 may include analysing, by the identifying module 204 and/or the extracting module 206, the segmented image and the at least one of the production image 400B and the baseline image 400A, based on a successful identification or a unsuccessful identification of the matching element, at step 506.

Upon successful identification of the matching element, the step 506 of the process 500 may include determining, by the extracting module 206, position coordinates of the matching element in the at least one of the production image 400B and the baseline image 400A, at step 508. By way of an example, when an exact match may be found in the target image corresponding to the segmented image, then the at least one of the production image 400B and the baseline image 400A may be sent to a position marking module to highlight the matched element.

Upon unsuccessful identification of the matching element, the step 506 of the process 500 may include identifying, by the identifying module 204, a nearest matching element corresponding to the segmented image using the similarity check algorithm, based on a predefined threshold similarity score, at step 510. In some embodiments, even though the segmented image may be present in the target image (i.e. at least one of the production image 400B and the baseline image 400A) due to dimensions (or as resolution) changes, there may be chances of reporting as match may not be found. Further the un-matched element may be passed to the similarity check algorithm, where it may be tries to find any nearest match to an X-factor which may be the part of the target image. The similarity check algorithm may be configured to check for a predefined threshold similarity score in a configuration file to identify the nearest match.

In some embodiments, the predefined threshold similarity score may not be provided in the configuration file. In that case, the default threshold similarity score may be considered (e.g., the predefined threshold similarity scores may be greater than 70%). Further, the identified differences in the target image along with the position coordinates may be passed to the position marking module to highlight the nearest matches.

Further, the process 500 may include rendering, by the rendering module 212, a segmented image report based on the analysis on the user device, at step 512. The segmented image report may be in the format of, for example, but may not be limited to, Portable Document Format (PDF), word document (DOC or DOCX), Microsoft excel spreadsheet files (XLS and XLSX), and HTML. The segmented report may include information of, for example, but may not be limited to, a match number, position coordinates and a quadrant. The quadrant may correspond to that area where the matches may be found. The quadrant may be predefined as Q1 (i.e. top left), Q2 (i.e. top right), Q3 (i.e. bottom left), Q4 (i.e. bottom right), and Q5 (i.e. center).

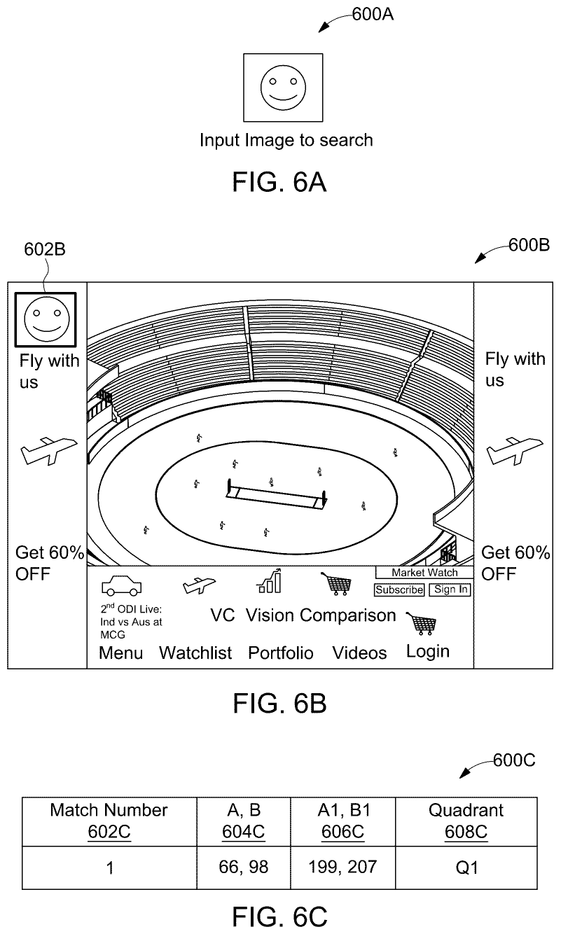

Referring now to FIGS. 6A-6C, generation of an exemplary segmented image report is illustrated, in accordance with some embodiments of the present disclosure. FIGS. 6A-6C are explained in conjunction with FIGS. 1-5.

In FIG. 6A, a segmented image 600A is illustrated. The receiving module 202 may receive the segmented image 600A from the user device. By way of an example, the segmented image 600A may be an element (e.g., symbol of smiley) that needs to be validated. The segmented image 600A may also be referred to as an X-factor.

In FIG. 6B, a target image 600B is illustrated. The receiving module 202 may receive the target image 600B from the user device. The computing device 102 may detect whether the segmented image 600A is present in the target image 600B or not. The target image 600B may be a baseline image (such as the baseline image 400A) or a production image (such as the production image 400B) or both. The computing device 102 may search for the segmented image 600A in the baseline image or the production image using the below described logic.

Upon receiving the segmented image 600A and the target image 600B, the identifying module 204 may identify a matching element 602B corresponding to the segmented image 600A in the target image 600B. It should be noted that the matching element 602B is an exact (i.e., 100%) match with the segmented image 600A.

Further, the identifying module 204 may analyze the segmented image 600A and the target image 600B, based on the successful identification of the matching element 602B. Upon successful identification of the matching element, the target image 600B may be sent to the extracting module 206 to highlight the identified matching element 602B. Further, the position coordinates of the matching element 602B may be determined in the target image 600B.

In FIG. 6C, a segmented image report 600C is illustrated. The rendering module 212 may render the segmented image report 600C based on the analysis on the user device. The segmented image report 600C may include a column for match number 602C, a column for position coordinates of top left point of the ROI (A, B) 604C, a column for position coordinates of bottom right point of the ROI (A1, B1) 606C, and a column for Quadrant 608C of the target image where the matching element is found. The match number 602C may denote a number of the matching element. The quadrant 608C may indicate the quadrant number in which the matching element 602B may lie in the production image 600B.

By way an example, for the matching element 602B, the match number 602C may be ‘1’. The position coordinates (A, B) 604C may be (66, 98). The position coordinates (A1, B1) 606C may be (199, 207), and the quadrant 608C may be ‘Q1’.

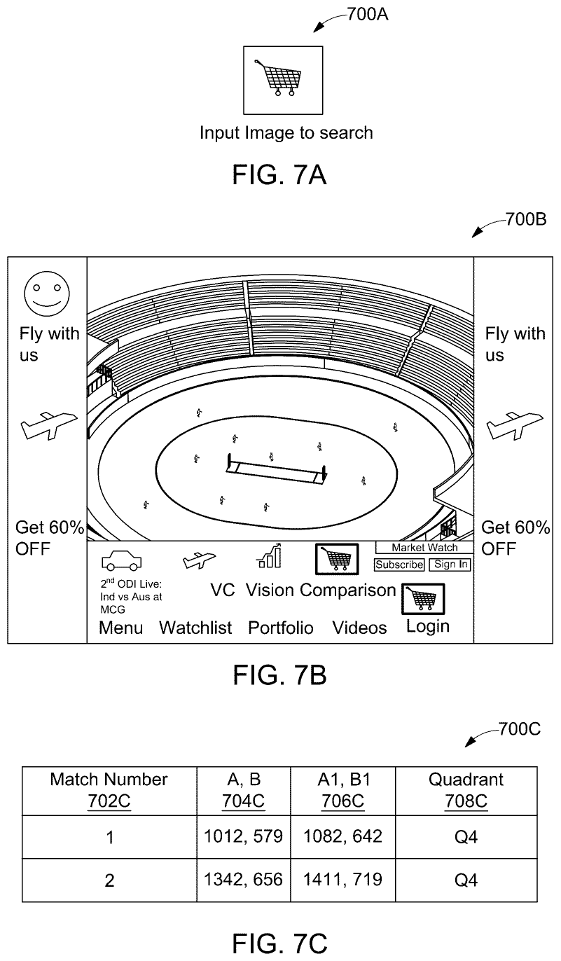

Referring now to FIGS. 7A-7C, generation of another exemplary segmented image report is illustrated, in accordance with some embodiments of the present disclosure. FIGS. 7A-7C are explained in conjunction with FIGS. 5-6A-C.

In FIG. 7A, a segmented image 700A is illustrated. The segmented image 700A may be received from the user device. By way of an example, the segmented image 700A may be an icon (e.g., an image of a shopping cart) that needs to be validated.

In FIG. 7B, a target image 700B is illustrated. The receiving module 202 may receive the target image 700B from the user device. The computing device 102 may detect whether the segmented image 700A is present in the target image 700B or not. The target image 700B may be a baseline image (such as the baseline image 400A) or a production image (such as the production image 400B) or both. The computing device 102 may search for the segmented image 700A in the baseline image or the production image using the below described logic.

Upon receiving the segmented image 700A and the target image 700B, the identifying module 204 may identify a matching element 702B and a matching element 704B corresponding to segmented image 700A in the target image 700B. It should be noted that each of the matching element 702B and the matching element 704B is an exact (i.e., 100%) match with the segmented image 700A.

Further, the identifying module 204 may analyse the segmented image 700A and the target image 700B, based on the successful identification. Upon successful identification of the matching element, the target image 700B may be sent to the extracting module 206 to highlight the identified matching elements (i.e., the matching element 702B and the matching element 704B). In other words, if there are multiple occurrences of the segmented image 700A in the target image 700B, then all the occurrences may be highlighted with a corresponding match number on the target image. Further, the position coordinates of the matching elements may be determined by the extracting module 206 in the target image 700B.

In FIG. 7C, a segmented image report 700C is illustrated. The segmented image report 700C may be analogous to the segmented image report 600C. The segmented image report 700C may be presented in a tabular format. The segmented image report 700C may include a column for match number 702C, a column for position coordinates (A, B) 704C, a column for position coordinates (A1, B1) 706C, and a column for quadrant 708C. By way of an example, the matching element 702B may have the match number 702C ‘1’, the position coordinates (A, B) 704C may be (1012, 579), the position coordinates (A1, B1) 706C may be (1082, 642), and the quadrant 708C may be “Q4” because element 702B may be located in the bottom right in the target image 700B. Similarly, for the matching element 704B, the match number 702C may be ‘2’, the position coordinates 704C may be (1342, 656), the position coordinates 706C may be (1411, 719), and the quadrant 708C may be ‘Q4’.

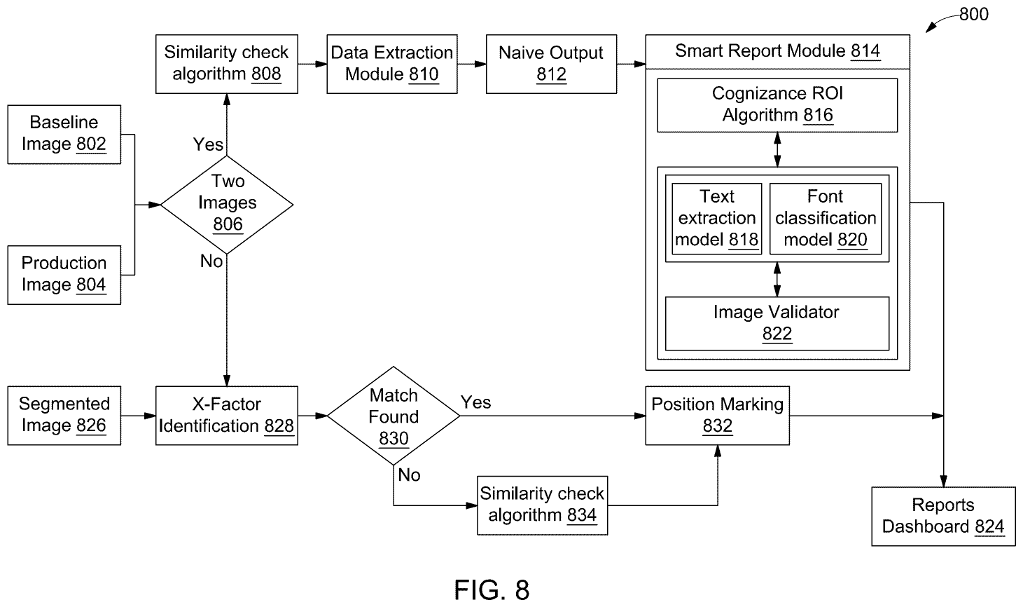

Referring now to FIG. 8, a detailed exemplary control logic 800 for validating images with observations is illustrated via a flow chart, in accordance with some embodiments of the present disclosure. FIG. 8 is explained in conjunction with FIGS. 1-7A-C.

In an exemplary scenario, the user may want to validate images with observations and prepare a detailed validation report. The receiving module 202 may receive the input image data 214 from the user device. In an embodiment, the receiving module 202 may receive a baseline image 802 (such as the baseline image 400A) and a production image 804 (such as the production image 400B) from the user device. The baseline image 802 and the production image 804 may be received in one of the image-to-image combination option, the image-to-URL combination option, the URL-to-image combination option, or the URL-to-URL combination option.

Further, at step 806 of the control logic 800, a check may be performed to determine whether the input image data 214 includes two images (i.e., the baseline image 802 and the production image 804). If the input image data 214 includes the baseline image 802 and the production image 804, then the plurality of deviations may be identified in the production image 804 based on a comparison with the baseline image 802 using a similarity check algorithm 808. The similarity check algorithm 808 may verify the image format and ensure to convert both the images (i.e., baseline image 802 and the production image 804) to suitable format for image validation. In addition, the similarity check algorithm 808 may also check for the image quality to apply pre-processing methods on need basis to improve the image richness.

Further, the extracting module 206 may perform data extraction 810 to generate a naïve output 812 (i.e., the first output). The naïve output 812 may include bounding boxes of different shapes and colours highlighting all the identified plurality of deviations in the production image 804. The naïve output 812 may include position coordinates of each of the plurality of deviations. Further, the extracting module 206 may also assign the first unique ID to each of the plurality of deviations identified in the production image 804.

Further, the naïve output 812 may be sent to a smart report module 814 for further processing. The smart report module 814 may include a cognizance ROI algorithm 816, a text extraction model 818, a font classification model 820, and an image validator 822. The cognizance ROI algorithm 816 may create one or more ROIs based on the position coordinates of each of the plurality of deviations in the naïve output 812. It should be noted that each of the one or more ROIs may include at least one deviation of the plurality of deviations. The cognizance ROI algorithm 816 may be based on AI. The cognizance ROI algorithm 816 may detect the position coordinates of each of the plurality of deviations in the naïve output 812 and may group the deviations that are overlapping, have many smaller regions present inside a larger region, or are located at a minimal distance, etc. The cognizance ROI algorithm 816 may represent each group as a single ROI. Further, the cognizance ROI algorithm 816 may assign the second unique ID to each of the one or more ROIs.

The naïve output 812 along with ROIs may then be sent to a text extraction model 818 to identify one or more text deviations in the ROIs. In an embodiment, the text extraction model 818 may be a deep learning-based OCR model. The text extraction model 818 may extract text from the ROI and may perform validation for the extracted text. The validation for text may include checking for missing text, new text, addition to text, change in size of text, change in colour of text, shift in position of text, change in alignment of text, etc. Further, the text extraction model 818 may transmit the ROIs to a font classification model 820 to identify one or more font deviations (i.e., deviation in font style) in the ROIs.

The font classification model 820 may be based on deep learning. It should be noted that the naïve output 812 along with the ROIs may be sent to the text extraction model 818 and the font classification model 820 only when the ROIs may include text information. In all other cases the naïve output 812 along with the ROIs may be directly sent to an image validator model 822. The image validator model 822 may identify one or more image deviations in the ROIs. The one or more image deviations may include, for example, change in background colour, image shift, dimensions change, image missing, distinct image in place of original image, and the like. Upon completing the various image validations, the smart report module 814 may send validation results in form of the second output to a reports dashboard 824.

Further, the rendering module 212 may render the reports dashboard 824 on the user device. The reports dashboard 824 may include detailed information associated with each of the one or more ROIs present in the production image 804. The reports dashboard 824 may display a report (such as the report 216) including the detailed information on the GUI of the user device.

In another embodiment, if the input image data 214 includes one image (i.e., one of the baseline image 802 or the production image 804) and a segmented image 826, the identifying module 204 may perform an X-factor identification 828. The one image is the target image. The X-factor identification 828 includes searching for a matching element corresponding to the segmented image 826 in the target image. The X-factor identification 828 may allow the user to detect whether the segmented image 826 is present in the target image or not.

Further, at step 830 of the control logic 800, a check may be performed to determine whether a matching element is found in the target image or not. The identifying module 204 may analyse the segmented image 826 and the target image based on the successful identification or the unsuccessful identification of the matching element.

Upon successful identification of the matching element (i.e., if a matching element is found in the target image), the identifying module 204 may determine the position coordinates of the matching element in the target image through position marking 832. Further, through position marking 832, the identifying module 204 may highlight all the identified matching elements in the target image by drawing the bounding boxes around the matching elements.

Upon unsuccessful identification of the matching element (i.e., if a matching element is not found in the target image), the identifying module 204 may identify the nearest matching element corresponding to the segmented image 826 using a similarity check algorithm 834, based on a predefined threshold similarity score. The target image may be subjected to the similarity check algorithm 834 to find a nearest matching element to the segmented image 826. The similarity check algorithm 834 may check for the predefined threshold similarity score in the configuration file to identify the nearest matching element.

Further, the identified nearest matching element in the target image may be subjected to the position marking 832 to highlight all the identified nearest matching element by drawing the bounding boxes.

Further, the rendering module 212 may render a segmented image report to the reports dashboard 836 on the user device. The segmented image report may include the matching elements corresponding to the segmented image 826 and/or nearest matching elements to the segmented image 826, and position coordinates of each of the matching elements and the nearest matching elements.

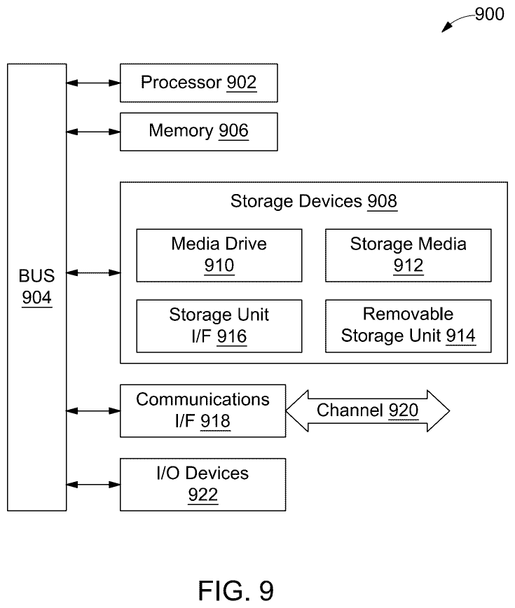

The disclosed methods and systems may be implemented on a conventional or a general-purpose computer system, such as a personal computer (PC) or server computer. Referring now to FIG. 9, an exemplary computing system 900 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 900 may represent, for example, a user device such as a desktop, a laptop, a mobile phone, personal entertainment device, DVR, and so on, or any other type of special or general-purpose computing device as may be desirable or appropriate for a given application or environment. The computing system 900 may include one or more processors, such as a processor 902 that may be implemented using a general or special purpose processing engine such as, for example, a microprocessor, microcontroller, or other control logic. In this example, the processor 902 is connected to a bus 904 or other communication medium. In some embodiments, the processor 902 may be an Artificial Intelligence (AI) processor, which may be implemented as a Tensor Processing Unit (TPU), or a graphical processor unit, or a custom programmable solution Field-Programmable Gate Array (FPGA).

The computing system 900 may also include a memory 906 (main memory), for example, Random Access Memory (RAM) or other dynamic memory, for storing information and instructions to be executed by the processor 902. The memory 906 also may be used for storing temporary variables or other intermediate information during execution of instructions to be executed by the processor 902. The computing system 900 may likewise include a read only memory (“ROM”) or other static storage device coupled to bus 904 for storing static information and instructions for the processor 902.

The computing system 900 may also include storage devices 908, which may include, for example, a media drive 910, a cloud based storage, a network storage, and a removable storage interface. The media drive 910 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 912 may include, for example, a hard disk, magnetic tape, flash drive, or other fixed or removable medium that is read by and written to by the media drive 910. As these examples illustrate, the storage media 912 may include a computer-readable storage medium having stored there in particular computer software or data.

In alternative embodiments, the storage devices 908 may include other similar instrumentalities for allowing computer programs or other instructions or data to be loaded into the computing system 900. Such instrumentalities may include, for example, a removable storage unit 914 and a storage unit interface 916, such as a program cartridge and cartridge interface, a removable memory (for example, a flash memory or other removable memory module) and memory slot, and other removable storage units and interfaces that allow software and data to be transferred from the removable storage unit 914 to the computing system 900.

The computing system 900 may also include a communications interface 918. The communications interface 918 may be used to allow software and data to be transferred between the computing system 900 and external devices. Examples of the communications interface 918 may include a network interface (such as an Ethernet or other NIC card), a communications port (such as for example, a USB port, a micro-USB port), Near field Communication (NFC), etc. Software and data transferred via the communications interface 918 are in the form of signals which may be electronic, electromagnetic, optical, or other signals capable of being received by the communications interface 918. These signals are provided to the communications interface 918 via a channel 920. The channel 920 may carry signals and may be implemented using a wireless medium, wire or cable, fiber optics, or other communications medium. Some examples of the channel 920 may include a phone line, a cellular phone link, an RF link, a Bluetooth link, a network interface, a local or wide area network, and other communications channels.

The computing system 900 may further include Input/Output (I/O) devices 922. Examples may include, but are not limited to a display, keypad, microphone, audio speakers, vibrating motor, LED lights, etc. The I/O devices 922 may receive input from a user and also display an output of the computation performed by the processor 902. In this document, the terms “computer program product” and “computer-readable medium” may be used generally to refer to media such as, for example, the memory 906, the storage devices 908, the removable storage unit 914, or signal(s) on the channel 920. These and other forms of computer-readable media may be involved in providing one or more sequences of one or more instructions to the processor 902 for execution. Such instructions, generally referred to as “computer program code” (which may be grouped in the form of computer programs or other groupings), when executed, enable the computing system 900 to perform features or functions of embodiments of the present invention.

In an embodiment where the elements are implemented using software, the software may be stored in a computer-readable medium and loaded into the computing system 900 using, for example, the removable storage unit 914, the media drive 910 or the communications interface 918. The control logic (in this example, software instructions or computer program code), when executed by the processor 902, causes the processor 902 to perform the functions of the invention as described herein.

Various embodiments provide method and system for validating images with observations. The disclosed method and system may receive a production image and a baseline image from a user device. Further, the disclosed method and system may identify a plurality of deviations in the production image from the baseline image using a similarity check algorithm. Further, the disclosed method and system may extract a first output corresponding to the plurality of deviations. The first output may include position coordinates of each of the plurality of deviations. Moreover, the disclosed method and system may create, by using a cognizance ROI algorithm, one or more ROIs based on the position coordinates of each of the plurality of deviations. Each of the one or more ROIs may include at least one deviation of the plurality of deviations. The cognizance ROI algorithm is based on AI. Thereafter, for each ROI of the one or more ROIs, the disclosed method and system may generate a second output corresponding to the ROI using one or more predictive models. The second output may include observations corresponding to each of the at least one deviation in the ROI.

Thus, the disclosed method and system try to overcome the technical problem of validating images with observations. In contrast to present comparison tools, which only highlight the differences between the two images, the disclosed method and system highlight the differences and provide detailed report on each highlight along with nature of differences. This will reduce the testing turns around time with precious reports. The method and system provide a provision to include comparison tests as part of the functional test automation flows. However, no additional testing is required to identify the visual differences. The method and system eliminate the manual efforts to overcome the challenges in generating reports and may help the web developers, designers, and quality assurance teams to perform image validation seamlessly. The method and system provide another provision to capture the images from the URL of the application in real-time. This will ensure that images will always compare with the latest deployed version. The method and system provide the pixel-level differences precisely, efficiently and making it easier by providing a meaningful output of the differences highlighted with numbering. The method and system provide various browser options to validate images in the form of headless, normal mode and the like.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only.

What is claimed is:

1. A method for validating images with observations, the method comprising:
receiving, by a computing device, a production image and a baseline image from a user device;
identifying, by the computing device, a plurality of deviations in the production image from the baseline image using a similarity check algorithm;
extracting, by the computing device, a first output corresponding to the plurality of deviations, wherein the first output comprises position coordinates of each of the plurality of deviations;
creating, by the computing device using a cognizance ROI algorithm, one or more Regions of Interest (ROIs) based on the position coordinates of each of the plurality of deviations, wherein each of the one or more ROIs comprises at least one deviation of the plurality of deviations, and wherein the cognizance ROI algorithm is based on Artificial Intelligence (AI); and
for each ROI of the one or more ROIs, generating, by the computing device, a second output corresponding to the ROI using one or more predictive models, wherein the second output comprises observations corresponding to each of the at least one deviation in the ROI.

2. The method of claim 1, further comprising assigning, by the computing device, a first unique identity (ID) to each of the plurality of deviations, wherein the first output further comprises the first unique ID of each of the plurality of deviations.

3. The method of claim 1, further comprising assigning, by the computing device, a second unique ID to each of the one or more ROIs, wherein the second output further comprises the second unique ID of each of the one or more ROIs.

4. The method of claim 1, wherein generating the second output corresponding to the ROI further comprises:
for each ROI of the one or more ROIs,
identifying, by the computing device, a text deviation in the ROI using a text extraction model, wherein the text extraction model is based on deep learning;
identifying, by the computing device, a font deviation in the ROI using a font classification model, wherein the font classification model is based on the deep learning; and
identifying, by the computing device, an image deviation in the ROI using an image validator model.

5. The method of claim 1, further comprising:
receiving, by the computing device, a segmented image and at least one of the production image and the baseline image from the user device;
identifying, by the computing device, a matching element corresponding to the segmented image from the at least one of the production image and the baseline image;
analyzing, by the computing device, the segmented image and the at least one of the production image and the baseline image, based on a successful identification or an unsuccessful identification of the matching element; and
rendering, by the computing device, a segmented image report based on the analysis on the user device.

6. The method of claim 5, wherein analyzing the segmented image and the at least one of the production image and the baseline image comprises, one of:
upon successful identification of the matching element, determining, by the computing device, position coordinates of the matching element in the at least one of the production image and the baseline image; or
upon unsuccessful identification of the matching element, identifying, by the computing device, a nearest matching element corresponding to the segmented image using the similarity check algorithm, based on a predefined threshold similarity score.

7. The method of claim 1, further comprising:
identifying, by the computing device, a cursor position on a Graphical User Interface (GUI) from the user device; and
when the cursor position corresponds to the position coordinates of an ROI from the one or more ROIs,
rendering, by the computing device, the observations as a callout corresponding to each of the at least one deviation in the ROI.

8. The method of claim 1, further comprising rendering, by the computing device, a report based on the second output on the user device.

9. A system for validating images with observations, the system comprising:
a processor; and
a memory communicatively coupled to the processor, wherein the memory stores processor executable instructions, which, on execution, causes the processor to:
receive a production image and a baseline image from a user device;
identify a plurality of deviations in the production image from the baseline image using a similarity check algorithm;
extract a first output corresponding to the plurality of deviations, wherein the first output comprises position coordinates of each of the plurality of deviations;
create, using a cognizance ROI algorithm, one or more Regions of Interest (ROIs) based on the position coordinates of each of the plurality of deviations, wherein each of the one or more ROIs comprises at least one deviation of the plurality of deviations, and wherein the cognizance ROI algorithm is based on Artificial Intelligence (AI); and
for each ROI of the one or more ROIs, generate, a second output corresponding to the ROI using one or more predictive models, wherein the second output comprises observations corresponding to each of the at least one deviation in the ROI.

10. The system of claim 9, wherein the processor executable instructions further cause the processor to assign a first unique identity (ID) to each of the plurality of deviations, wherein the first output further comprises the first unique ID of each of the plurality of deviations.

11. The system of claim 9, wherein the processor executable instructions further cause the processor to assign a second unique ID to each of the one or more ROIs, wherein the second output further comprises the second unique ID of each of the one or more ROIs.

12. The system of claim 9, wherein to generate the second output corresponding to the ROI, the processor executable instructions further cause the processor to:
for each ROI of the one or more ROIs,
identify a text deviation in the ROI using a text extraction model, wherein the text extraction model is based on deep learning;
identify a font deviation in the ROI using a font classification model, wherein the font classification model is based on the deep learning; and
identify an image deviation in the ROI using an image validator model.

13. The system of claim 9, wherein the processor executable instructions further cause the processor to:
receive a segmented image and at least one of the production image and the baseline image from the user device;
identify a matching element corresponding to the segmented image from the at least one of the production image and the baseline image;
analyze the segmented image and the at least one of the production image and the baseline image, based on a successful identification or an unsuccessful identification of the matching element; and
render a segmented image report based on the analysis on the user device.

14. The system of claim 13, wherein to analyze the segmented image and the at least one of the production image and the baseline image, the processor executable instructions further cause the processor to, one of:
upon successful identification of the matching element, determine position coordinates of the matching element in the least one of the production image and the baseline image; or
upon unsuccessful identification of the matching element, identify a nearest matching element corresponding to the segmented image using the similarity check algorithm, based on a predefined threshold similarity score.

15. The system of claim 9, wherein the processor executable instructions further cause the processor to:
Identify a cursor position on a Graphical User Interface (GUI) from the user device; and
when the cursor position corresponds to the position coordinates of an ROI from the one or more ROIs,
render the observations as a callout corresponding to each of the at least one deviation in the ROI.

16. The system of claim 9, wherein the processor executable instructions further cause the processor to render a report based on the second output on the user device.

17. A non-transitory computer-readable medium storing computer-executable instructions for validating images with observations, the computer-executable instructions configured for:
receiving a production image and a baseline image from a user device;
identifying a plurality of deviations in the production image from the baseline image using a similarity check algorithm;
extracting a first output corresponding to the plurality of deviations, wherein the first output comprises position coordinates of each of the plurality of deviations;
creating, using a cognizance ROI algorithm, one or more Regions of Interest (ROIs) based on the position coordinates of each of the plurality of deviations, wherein each of the one or more ROIs comprises at least one deviation of the plurality of deviations, and wherein the cognizance ROI algorithm is based on Artificial Intelligence (AI); and
for each ROI of the one or more ROIs, generating a second output corresponding to the ROI using one or more predictive models, wherein the second output comprises observations corresponding to each of the at least one deviation in the ROI.

18. The non-transitory computer-readable medium of claim 17, wherein for generating the second output corresponding to the ROI, the computer-executable instructions are further configured for:
for each ROI of the one or more ROIs,
identifying, by the computing device, a text deviation in the ROI using a text extraction model, wherein the text extraction model is based on deep learning;
identifying, by the computing device, a font deviation in the ROI using a font classification model, wherein the font classification model is based on the deep learning; and
identifying, by the computing device, an image deviation in the ROI using an image validator model.

19. The non-transitory computer-readable medium of claim 17, wherein the computer-executable instructions are further configured for:
receiving, by the computing device, a segmented image and at least one of the production image and the baseline image from the user device;
identifying, by the computing device, a matching element corresponding to the segmented image from the at least one of the production image and the baseline image;
analyzing, by the computing device, the segmented image and the at least one of the production image and the baseline image, based on a successful identification or an unsuccessful identification of the matching element; and
rendering, by the computing device, a segmented image report based on the analysis on the user device.

20. The non-transitory computer-readable medium of claim 19, wherein for analyzing the segmented image and the at least one of the production image and the baseline image, the computer-executable instructions are configured for, one of:
upon successful identification of the matching element, determining, by the computing device, position coordinates of the matching element in the at least one of the production image and the baseline image; or
upon unsuccessful identification of the matching element, identifying, by the computing device, a nearest matching element corresponding to the segmented image using the similarity check algorithm, based on a predefined threshold similarity score.
